(19) United States
(12) Patent Application Publication
(10) Pub. No.: US 2020/0210664 A1
(43) Pub. Date: Jul. 2, 2020

(54) Optically Readable Markers

(71) Applicant: Zappar Limited, Auchterarder, Perthshire, Scotland (GB)

(72) Inventor: Simon Taylor, Auchterarder, Perthshire, Scotland (GB)

(21) Appl. No.: 16/643,709

(22) PCT Filed: Aug. 22, 2018
(86) PCT No.: PCT/GB2018/052383

§ 371 Date: Mar. 2, 2020

(30) Foreign Application Priority Data
Sep. 7, 2017 (GB) 1714405.6

(51) Int. Cl. G06K 7/14; G06K 9/20; G06K 19/06

(52) U.S. Cl. CPC G06K 7/1443; G06K 7/1447; G06K 2019/06262; G06K 19/06037; G06K 19/06112; G06K 9/2063

(57) ABSTRACT

An optically readable marker includes data to be extracted; and an identifier arranged to identify a location of the data to be extracted. The identifier includes a plurality of dots arranged in a set pattern, the dots being small compared to the size of the data to be extracted. The identifier may be used on a beverage container, and/or for augmented reality applications.

The invention relates to optically readable markers, methods of marking objects or images with optically readable markers and methods of extracting data using optically readable markers. In particular, the invention relates to optically readable markers comprising an identifier arranged to allow a location of data to be extracted to be determined. In particular, but not exclusively, the invention relates to optically readable markers suitable for use on beverage containers.

Optical Character Recognition, or OCR, is the process of extracting text-based data from written or printed articles. OCR techniques have been developed since the earliest days of computers; much of the early potential for computers to increase efficiency of previous office workflows required an input mechanism that could “read” the data from structured forms and run processing on the data contained thereon.

In structured-form OCR applications, input documents are scanned through a device ensuring perfect alignment of the digitised image with the original input sheet. Various techniques have been previously developed for identifying the regions of the digitised image containing data to be interpreted with an OCR algorithm; ranging from pre-programming the system with the expected field locations, to special printed marks or the use of additional alignment holes and patterns along the edge of the input forms.

Other applications for OCR techniques involve more challenging input conditions where the data to be read is not necessarily at a known alignment or position in the input image, and where there is potentially significant background clutter that must be ignored. Embodiments of the present invention may relate to this more challenging setting.

The skilled person will appreciate that embodiments of the invention may be used with optically-readable barcodes or the like instead of, or as well as, text-based data. As such, other methods of optical reading as well as OCR are included in the scope of the present disclosure. The invention is described with respect to text-based data and OCR by way of example and for ease of reference.

In the prior art, as demonstrated by U.S. Pat. No. 4,776,464, the general concept of using a fixed target symbol or identification pattern to enable rapid detection and rectification of an area containing data of interest in a 2D image is known. Symbols such as concentric parallelograms of contrasting colours (U.S. Pat. No. 4,776,464), or boxes around the data of interest, are known.

According to a first aspect of the invention, there is provided an optically readable marker comprising data to be extracted; and an identifier. The identifier is arranged to identify a location of the data to be extracted. The identifier comprises a plurality of dots arranged in a set pattern.

The data are optically readable. The data may form an optically readable part of the optically readable marker.

The identifier may consist of the plurality of dots.

The dots may all be the same size.

The dots may be located adjacent the data to be extracted.

The dots may not overlap the data, nor be surrounded by the data. The dots may therefore be outside of the data region in some embodiments.

The data may comprise or consist of alphanumeric characters.

The data may be arranged in a grid. The plurality of dots may be adjacent to the grid in such embodiments.

The identifier may form a border around the data.

The dots may be small compared to the size of the data to be extracted.

The data may be text-based data, and each dot of the plurality of dots may be small compared to a character of the text-based data.

The identifier may comprise at least three dots.

The set pattern of the plurality of dots may be arranged to lack rotational symmetry, such that an orientation of the data can be uniquely established.

The set pattern of the plurality of dots may include dots located near at least two sides of the data.

The plurality of dots may include a first subset of dots arranged to indicate the presence of the identifier. Optionally, the plurality of dots may include a second subset of dots arranged to indicate the presence of the identifier.

In embodiments with a first and/or second subset of dots, the first and/or second subset of dots may be or comprise three collinear, equidistant dots.

A subset may comprise a maximum of four dots. A subset may comprise a maximum of three dots.

In embodiments with two (or more) subsets of dots, a distance between the first and second subsets may be set to be within an expected range of distances relative to the spacing of dots in the first subset. One or more areas within which the second subset is located, and/or a location of the second subset, and/or a distance range (e.g. a radius measured from the first subset) to be searched for the second subset, may therefore be determinable from the first subset, and optionally vice versa.

In embodiments with two subsets of dots, the marker may further comprise one or more further dots. The further dots may be located at positions determinable from the positions of the dots in the first and second subsets.

The data to be extracted may comprise at least one of the following:
(i) text-based data;
(ii) a barcode or QR code; and
(iii) encoded 2D binary data.

The dots may be small compared to the size of the data to be extracted. For example, the dots may be smaller than the data elements, with smaller meaning at least one of smaller area and smaller width and/or height.

The data to be extracted may comprise a plurality of data elements, e.g. letters, numbers, blocks, and/or symbols. Each data element may be a discrete mark; e.g. A B 1 2 ! *. Alternatively or additionally, the data elements may be conjoined but separable, e.g. [symbol] Alternatively or additionally, one or more of the data elements may comprise two or more discrete marks which are interpreted together to give a value; e.g.: =1, . . . =0, or the likes. Each dot of the plurality of dots may be small compared to a data element of the plurality of data elements.

The dots may surround the data to be extracted.

According to a second aspect of the invention, there is provided a beverage container comprising an optically readable marker according to the first aspect of the invention.

The beverage container may be a can, and the optically readable marker may be located on a ring pull of the can, for example on an underside of the ring pull.

The beverage container may be a bottle and the optically readable marker may be located on an inner surface of a lid of the bottle.

The optically readable marker may be provided by laser etched marks on a surface of the beverage container.

The surface with the marker may be a surface of a closure of the beverage container, such as a lid, other closure, or ring pull.

The optically readable marker may be located on a label of the beverage container.

According to a third aspect of the invention, there is provided a method of extracting data from an image, the method comprising:
acquiring a two-dimensional image;
identifying a plurality of dots arranged in a set pattern within the image, the plurality of dots being arranged to form an identifier;
determining a location of the data to be extracted based on the identifier; and
optically scanning the determined location so as to extract the data.

The acquiring a two-dimensional image may comprise taking a photograph or using a live frame of a camera.

The method may further comprise determining an orientation of the data to be extracted based on the identifier.

The identifying an identifier within the image may comprise:
detecting dots within the image;
identifying a first subset of dots which meet a first pre-set condition;
determining one or more expected positions of further dots based on the first subset of dots; and
searching for the further dots in the expected positions.

The determining one or more expected positions of further dots may comprise looking for a second subset of dots which meet a second pre-set condition with respect to the first subset of dots within an expected distance range of the first subset. The distance may be determined relative to the spacing of dots in the first subset.

The determining one or more expected positions of further dots based on the first subset of dots may comprise determining the one or more expected positions of the further dots based on the first and second subsets of dots.

The identifying each dot of the plurality of dots may comprise identifying a pixel that is either brighter or darker by more than a threshold than all of the n pixels in a ring around the identified pixel.

The optical scanning may comprise performing optical character recognition on the determined location. The optical character recognition may read the data.

According to a fourth aspect of the invention, there is provided a method of marking an image or object with an optically readable marker, the method comprising:
marking the image or object with data to be extracted; and
marking the image or object with an identifier arranged to identify a location of the data,
   wherein the identifier comprises a plurality of dots arranged in a set pattern.

The marking the object with the data to be extracted and with the identifier may comprise laser etching.

The object to be marked may be a beverage can ring pull or container lid.

The dots and the data to be extracted may have any of the features described with respect to the first aspect; for example, the dots may be small compared to the size of the data to be extracted and/or the data may comprise optically readable alphanumeric characters.

According to a fifth aspect of the invention, there is provided use of a marker as described in the first aspect for augmented reality applications.

Markers of the invention may address one or more of the following issues of prior art markers. They may:

1) Permit use of a rapid algorithm for detection so that detection can be practically implemented on currently available hardware;
2) Have unique features when compared to general image background, so that detections of the pattern of the marker are highly likely to be from true areas of interest rather than background;
3) Enable the image transformation to be determined (scale, orientation, viewing angle) so a rectified view of the data region can be produced; and
4) Minimise the area overhead added by the fixed pattern of the marker, so the overall scheme can be used in use-cases where the available space is limited.

The invention relates to a means for identifying a particular region of a 2D image containing data to be extracted. Embodiments of the invention may be well-suited for implementation on resource-constrained mobile devices such as smartphones. Embodiments of the invention may feature a very low area overhead, making the invention suitable for use in circumstances where the area available for marking the data is limited.

The skilled person would understand that features described with respect to one aspect of the invention may be applied, mutatis mutandis, to any other aspect of the invention.

There now follows by way of example only a detailed description of embodiments of the present invention with reference to the accompanying drawings in which:

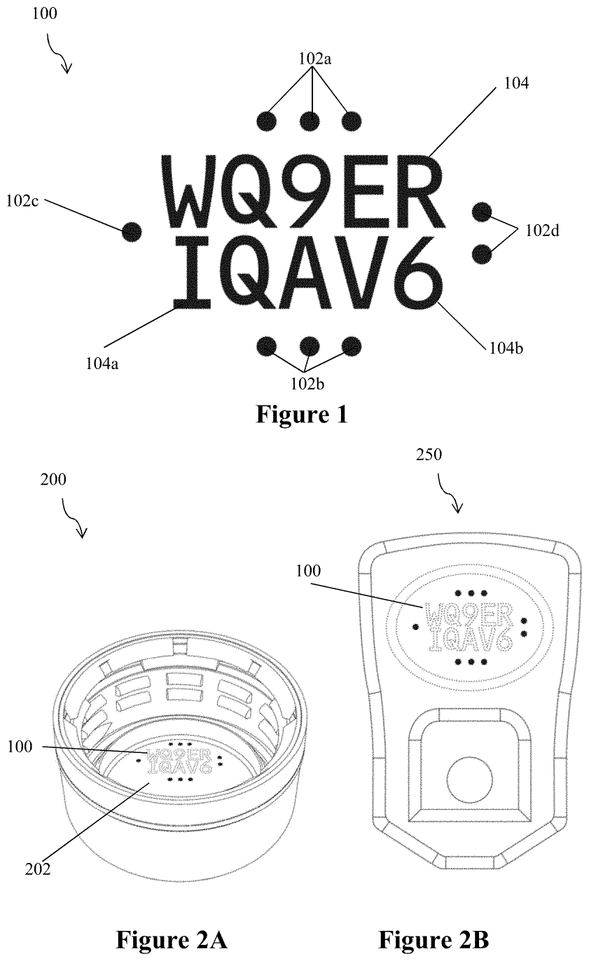

FIG. 1 shows a marker of an embodiment;

FIGS. 2A and 2B show the marker of FIG. 1 on a bottle lid and on a can ring pull, respectively;

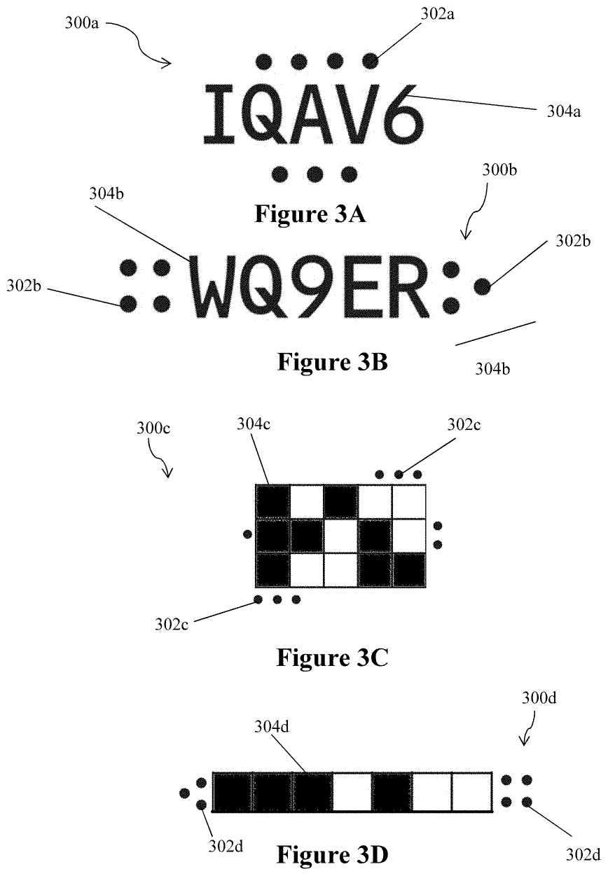

FIGS. 3A to 3D show markers of alternative embodiments;

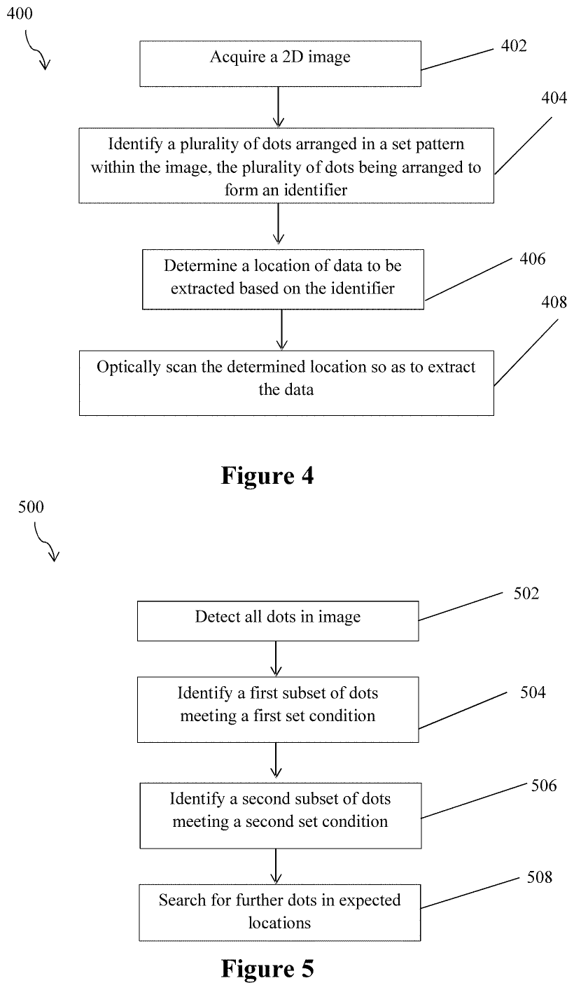

FIG. 4 shows a flow-chart of a method of extracting data using a marker according to an embodiment;

FIG. 5 shows a flow chart of steps for identifier detection which may be used in some embodiments;

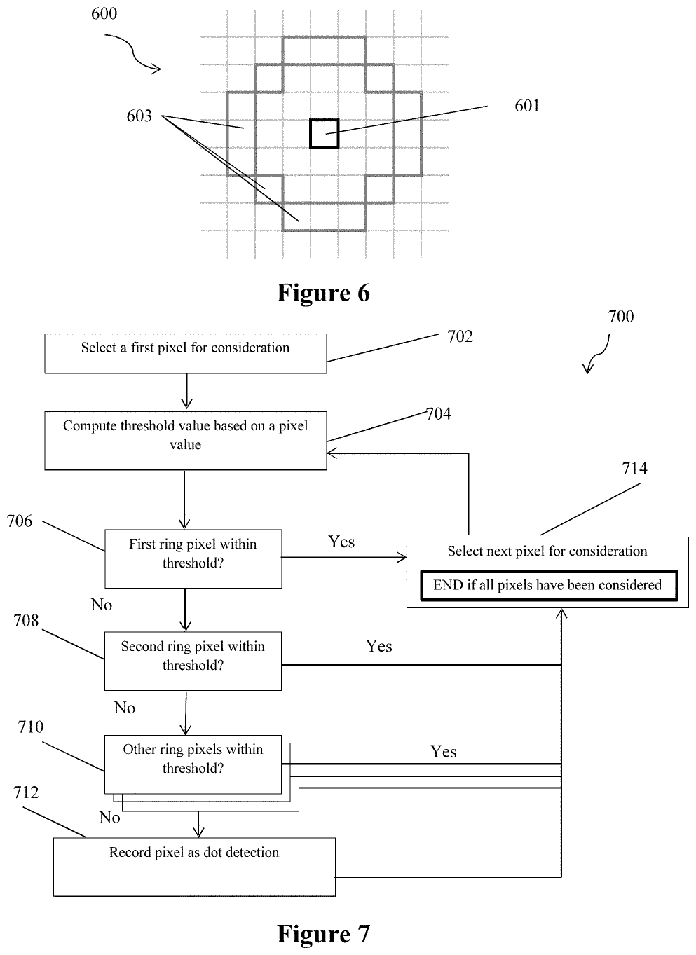

FIG. 6 is a schematic illustration of how pixels of an image may be divided up for analysis;

FIG. 7 shows a flow-chart of a method of dot identification which may be used in some embodiments;

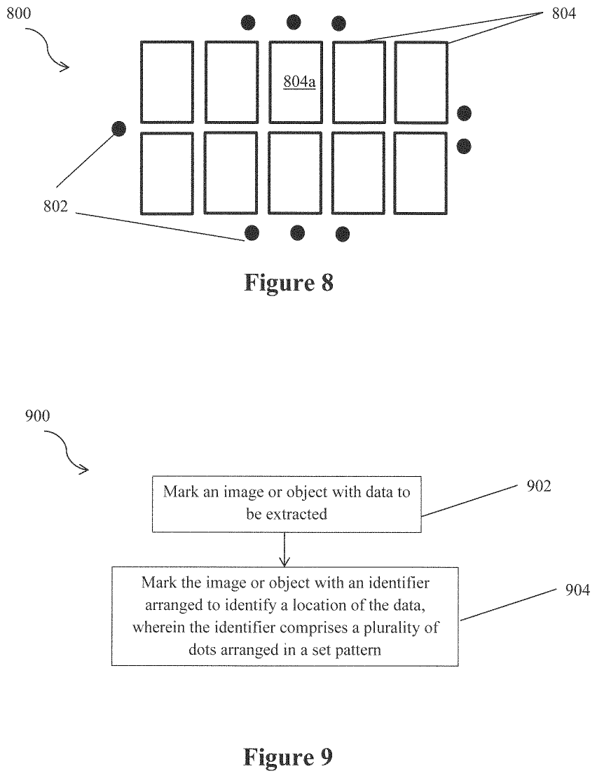

FIG. 8 is a schematic illustration of a reference pattern of an embodiment;

FIG. 9 shows a flow-chart of a marking method of an embodiment; and

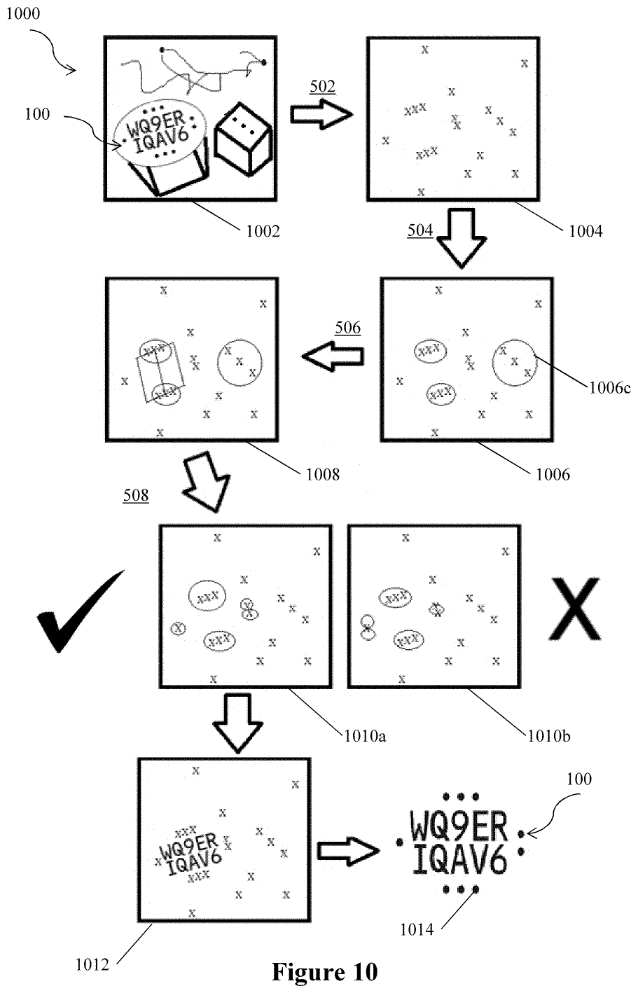

FIG. 10 is a graphical illustration of the method shown in FIG. 5.

FIG. 1 illustrates a marker 100 of an embodiment. The marker 100 is arranged to be optically readable.

The marker 100 comprises a plurality of dots 102 (102a-d) and data of interest 104. The data of interest 104 are optically readable.

In the embodiment being described, the data of interest 104 comprises text-based data, and in particular a set of alphanumeric characters. In alternative or additional embodiments, the data 104 may comprise one or more of the following:
(i) only letters;
(ii) only numbers;
(iii) one or more barcodes;
(iv) one or more 2D sets of binary data encoded as squares or dots, such as QR codes;
(v) one or more images; and/or
(vi) one or more logograms (for example Chinese characters).

In the embodiment being described, the text-based data 104 comprises ten alphanumeric characters 104a, 104b, arranged in two rows of five, so forming a rectangular grid of characters. In the embodiment being described, the alphanumeric characters are all at least approximately the same size, in that they are sized to fit within a rectangle of a prescribed size. In alternative or additional embodiments, the data 104 may comprise more or fewer characters, and/or the characters may be arranged differently and/or be of different sizes. Each alphanumeric character, e.g. 104a, 104b, may be referred to as a data element of the data 104.

In the embodiment being described, all of the characters 104 are the same size. The skilled person will appreciate that this may facilitate OCR.

In the embodiment being described, the dots 102 are located adjacent to the data 104.

In the embodiment being described, the dots 102 are all the same size as each other, and are small compared to the area covered by the data 104, and also small compared to each data element 104a, 104b.

In the embodiment being described, the dots 102 have a diameter of less than one third of the height of each data element 104a,b. In the embodiment being described, the dots 102 have a diameter of less than one half of the width of each data element 104a,b. In other embodiments, the dots 102 may be sized to have a diameter of between 10% and 75% of the width and/or height of the data elements 104a, b, and preferably between 10% and 50%.

In the embodiment being described, the dots 102 have a diameter of less than one sixth of the width of the data area 104. In the embodiment being described, the dots 102 have a diameter of less than one quarter of the height of the data area 104. In other embodiments, the dots 102 may be sized to have a diameter of between 1% and 75% of the width and/or height of the data area 104, and preferably between 1% and 40%.

In the embodiment being described, the dots 102 at least partially surround the data 104. In particular, in the embodiment being described, dots 102 are located on all four sides of the data 104.

In the embodiment being described, there is a gap between the data 104 and the dots 102, such that the data and dots do not overlap or interfere.

In particular, in this embodiment, the dots 102 are arranged in:
(i) a set 102a of three collinear and equally spaced dots above the data 104;
(ii) a set 102b of three collinear and equally spaced dots below the data 104;
(iii) a single dot 102c on the left-hand side of the data 104; and
(iv) a set 102d of two dots on the right-hand side of the data 104

In the embodiment being described, (hypothetical) lines through each of the two sets of three dots 102a, 102b would be at least substantially parallel to each other. Further, the lines would also be at least substantially parallel to the length of the area filled with data 104.

In the embodiment being described, the (hypothetical) line between the two dots 102d on the right-hand side of the data 104 is at least substantially perpendicular to the lines through each of the two sets of three dots 102a, 102b and at least substantially parallel to the height of the area filled with data 104.

In the embodiment being described, the one or more dots 102 on each side of the data 104 are arranged centrally with respect to that side of the data 104.

The skilled person will appreciate that the arrangement of dots 102 shown in FIG. 1 is provided as an example only—some alternative arrangements are discussed below with respect to FIG. 3.

The dots 102 may be thought of as small individual points. Dots 102 are arguably the smallest possible detectable features in images as only a single pixel is required to provide a dot. Dots 102 may be at least substantially circular, as in the embodiments shown. Dots 102 may also take other shapes, for example generally being square, e.g. in the case of a single pixel. In additional or alternative embodiments, dots may be triangular, rectangular, diamond-shaped, pentagonal, hexagonal, octagonal or of any other shape (regular or irregular). In the embodiments being described, the dots 102 are called dots, irrespective of shape—dots are small regions identifiably different from the surrounding background and are generally not elongated. Unlike line features, dots do not require an “edge” with a specific orientation to remain detectable. As long as a single pixel is brighter or darker than the surrounding region in the image then it is possible to detect the point. An efficient approach on current hardware for the detection of these individual points is described below.

The skilled person will appreciate that some of the dots identified may not be part of the identifier 102, for example being part of a background image. It is therefore necessary to determine which of the detected points in the image match each of the points in the reference pattern 102.

One way would be to make each dot 102 somehow identifiable; for example by making each one a different colour or a different size or shape. However, especially when the detected dots in images approach the size of a single pixel, any attempt to extract identity information from a single dot may be inaccurate.

According to embodiments described herein, the pattern of dots 102 is selected such that when the pattern is detected the location of the data 104 can be determined without any need to extract identity information from the constituent points in the pattern.

An individual point (dot 102) is unlikely to be a unique feature—most natural images contain some areas that are lighter or darker than the surrounding image region and so may appear as dots. Additionally a single point provides no information on orientation, and very limited scale information. Therefore a single point is generally not used as an identifier 102 by itself—it is likely not to be unique, and does not enable a full image transformation to be calculated.

By combining multiple dots 102 into a fixed pattern, it is possible to increase the likelihood of uniqueness and to provide the ability to calculate a full image transformation. At the same time, use of an efficient detection algorithm is possible, as is a low area overhead for the identifier.

The skilled person will appreciate that the arrangement of dots 102 is preferably chosen in such a way as to provide a low probability of the same arrangement or pattern being present outside of the marker 100. For example, if the marker 100 is printed on a label of a product, the presence of a single row of three dots on the label may be likely (e.g. as an ellipsis in text, or in a row of dots separating sections of a label)—a pattern more complex than a single row of dots 102 may therefore be selected.

FIG. 2A shows a bottle cap 200. The bottle cap 200 of the embodiment being described is for a beverage-containing bottle. The skilled person will appreciate that, in other embodiments, a corresponding bottle top could be used for any bottle or contents.

The bottle cap 200 is marked with the marker 100 shown in FIG. 1. In particular, in the embodiment being described, the marker 100 is located on an inner surface 202 of the bottle cap 200, and in particular on the surface 202 arranged to lie across the opening of the bottle in use. In the embodiment being described, this surface 202 is at least substantially flat. Advantageously, this may facilitate optical reading of the marker.

In the embodiment being described, the bottle cap 200 is made of plastic.

The skilled person will appreciate that the same principles can be applied to other container closures, and that the closures may be made of plastic or of other materials such as metal or cardboard.

FIG. 2B shows a ring pull 250. The ring pull 250 of the embodiment being described is for a beverage-containing can. The skilled person will appreciate that, in other embodiments, a corresponding ring pull could be used for any tin or can or the likes.

The ring pull 250 is marked with the marker 100 shown in FIG. 1. In particular, in the embodiment being described, the marker 100 is located on the portion of the ring pull 250 arranged to be gripped by a user.

In the embodiment being described, the marker 100 is provided on the underside of the ring pull 250 so that the data cannot be read until the can is opened. The skilled person will appreciate that marking an underside may be advantageous in use of the marker as a promotional code, as a user cannot tell whether or not the code is a winning code until the can has been (purchased and) opened.

In the embodiment being described, the ring pull 250 is coated with a dark lacquer that is then laser etched to produce the marker 100. As such, although the marker 100 is shown as being darker than the ring pull 250 in the drawings, the marker 100 would be lighter than its background in some embodiments. In alternative or additional embodiments, other marking techniques such as ink jet marking may be used, and/or no lacquer or a different lacquer may be used. Markers 100 may therefore be lighter or darker than their backgrounds, may be a different colour, and/or may be raised or textured differently.

In alternative or additional embodiments, the marker 100 may be applied to a label, for example forming part of packaging, and the packaging may be metallic, plastic or paper, amongst other options known in the art.

In alternative or additional embodiments, the marker 100 may be applied to a body of a container, for example being etched or printed onto a plastic, glass, metallic or paper bottle, carton or the likes.

The marker 100 may therefore be applied to any surface of a container, e.g. a beverage container, whether that surface is on a detachable closure (such as a cap 200 or ring pull 250) or on a body of the container.

In further embodiments, the marker 100 may be applied to any surface, for example a surface of an article or a picture (e.g. of a poster). Beverage containers are described by way of example only and the skilled person will appreciate that the invention's utility is not limited thereto.

FIGS. 3A to 3D show markers 300a-d of alternative embodiments.

The marker 300a shown in FIG. 3A comprises the data of interest 304a and an identifier 302a.

The data 304a comprises a row of alphanumeric characters; in this case, five characters.

The identifier 302a comprises two rows of equally spaced dots 302a. The identifier 302a comprises a row of four dots above the data 304a and a parallel row of three dots below the data 304a. The rows are oriented parallel to the data. The rows are located centrally with respect to the data. Dots 302a are present on only two sides of the data 304.

The marker 300b shown in FIG. 3B comprises the data of interest 304b and an identifier 302b.

The data 304b comprises a row of alphanumeric characters; in this case, five characters.

The identifier 302b comprises two sets of dots 302b. The identifier 302b comprises a square of four dots on the left hand side of the data 304b and a triangle of three dots on the right hand side of the data 304b. The dots 302b are in line with the data 304b.

The skilled person will appreciate that the design shown in FIG. 3B may be particularly useful when available space is limited in one dimension.

The marker 300c shown in FIG. 3C comprises the data of interest 304c and an identifier 302c.

The data 304c comprises binary data encoded in a 2D grid.

The identifier 302c comprises four sets of dots 302c. The identifier 302c comprises two parallel rows of three equally spaced dots on opposite sides of the data 304c. The two rows of dots 302c are located near edges of the data 304c, not centrally. The identifier 302c further comprises a single dot located centrally on the left hand side of the data 304c and a pair of dots located centrally on the right hand side of the data 304c.

The marker 300d shown in FIG. 3D comprises the data of interest 304d and an identifier 302d.

The data 304d comprises binary data encoded in 1D.

The identifier 302d comprises two sets of dots 302d. The identifier 302d comprises a square of four dots on the left hand side of the data 304d and a triangle of three dots on the right hand side of the data 304d. The dots 302d are in line with the data 304d.

The skilled person will appreciate that the design shown in FIG. 3D may be particularly useful when available space is limited in one dimension.

FIG. 4 shows a flow-chart of a method 400 of extracting data using a marker 100.

At step 402, a two-dimensional (2D) image is acquired at a processor. The image may be a photograph (e.g. of a 3D object or scene, or of a 2D surface), one or more live images from a camera, a scanned-in image, an image received by email or the likes.

The skilled person will appreciate that, with current technology, digital images are generally captured as a two-dimensional array of individual pixels. In current hardware setups, images are generally presented for processing as a complete “frame” of data, containing all of the pixels in a particular image.

This is distinct from line-scanning cameras, which deliver the image data one horizontal line at a time.

At step 404, a plurality of dots 102 arranged in a set pattern within the image are identified. The plurality of dots 102 are arranged to act as an identifier to identify the location of data 104 to be extracted. The set pattern or arrangement of the dots 102, which may be referred to as a reference pattern, provides the identifier.

At step 406 a location of the data 104 to be extracted is determined based on the identifier 102.

At step 408, the determined location is scanned optically so as to extract the data 104. In the case of text-based data 104, optical character recognition is performed at step 408. In alternative or additional embodiments, the optical scanning may comprise reading a barcode, performing image recognition, or the likes.

FIG. 5 provides a method 500 for carrying out the step 404 of identifying the identifier (i.e. the plurality of dots 102 marking the location of the data 104) within the image. The skilled person will appreciate that other methods may be used, but that the method 500 described with respect to FIG. 5 may improve computational efficiency by narrowing search scope.

FIG. 10 provides a graphic illustration 1000 of the method 500 of FIG. 5.

At step 502, dots 102, 1004 are identified within an image 1002. Some of the dots 102, 1004 are dots 102 of an identifier 102. Other dots 1004 result from the image background.

In the embodiment being described, the dot detection step 502 identifies pixels in the centre of a “point”, “circle” or “dot” feature in the image—a small area that is brighter or darker than the surrounding image region; the area may be circular, or, in the extreme, may be a single pixel.

At step 504, first subsets 102a, 1006 of dots which meet a first set condition are identified. The first set condition is a particular geometric relation between the dots 102a, 1004. In the example shown in FIG. 1, the first set condition is that the first subset 102a, 1006 of dots comprises three collinear dots, with equal spacings between them.

The skilled person will appreciate that such subsets of dots 102 may be extracted from a set of individual point detections as shown in FIG. 10. As described below, these subsets 1006 may be used to narrow the search for the full identification pattern.

At step 506, a second subset 102b, 1008 of dots which meet a second set condition is identified. The second set condition is a particular geometric relation between the dots 102b of the second subset (within the subset), and a particular geometric relation with the dots 102a of the first subset (between subsets). For the example shown in FIG. 1, the second set condition is that the second subset 102b of dots comprises three collinear dots, with equal spacings between them and that the second subset of dots 102b is substantially parallel to, and within a set distance of, the first subset of dots 102a.

Further, in the embodiment being described with respect to FIG. 1, the distances between the points (dots) in each subset are approximately equal. Furthermore, a line joining the centre points of each subset would be approximately perpendicular to the lines through the subsets 102a, 102b of points, and the distance between the subsets is within an expected range of distances relative to the length of lines through the two subsets of points.

The skilled person will appreciate that the set distance condition reduces the geometric area to be searched for the second subset 102b.

In the example shown in FIG. 10, the subset of three collinear dots 1006c resulting from the image background is rejected as being part of an identifier 102 at this stage, as no corresponding second subset is found.

In the embodiment being described, the method 400, 500 is arranged to work for photographs of marked objects 200, 250. As photographs may be taken from different angles and distances, the set distance is determined in terms of dot size and/or spacing of the dots of the first subset 102b, as the photograph size may vary.

At step 508, the remaining dots 102c, 102d of the pattern that are not in either the first 102a or second 102b subset are sought in their expected locations. The expected locations are computed based on knowledge of the reference pattern and the identification of the first and second subsets 102a, 102b.

In the embodiment being described with respect to FIG. 1, the left and right points 102c, 102d are sought in their expected locations.

After step 506, sufficient correspondences of points have been determined to enable computation of the affine image transformation to align the reference pattern with the detected points 102a, 102b. However, in this embodiment, there is still some ambiguity remaining due to the rotational symmetry of the two subsets 102a, 102b identified—there remain two potential transformations between the reference pattern and the identified dots 102a, 102b after step 506 as it is unknown which of the two subsets of points represents the top row of points from the reference pattern, and which the bottom. There are therefore two sets of expected locations 1010a, 1010b to be tested for the remaining dots 102c, 102d.

By computing transformations for both possibilities 1010a, 1010b it is possible to confirm which is correct by checking the left and right dots 102c, 102d in the pattern for support. As the left and right sides have different dot arrangements, there will only be detected points in the expected locations when using the correct one of the two possible transformations 1010a; this enables the correct location and orientation of the marker 100 to be determined 1012.

In the embodiments being described, the measurements used to verify the configuration of multiple subsets of dots 102 in steps 504 to 508 have acceptance regions rather than requiring precise values. The skilled person will appreciate that, under an affine transformation, the ratios of lengths and perpendicular angles may not be exactly preserved, and that some lenience may therefore allow different viewing angles and the likes to be accommodated.

In alternative or additional embodiments, the first and second subsets 102a, 102b may be designed to lack rotational symmetry, such that identification of the two subsets is sufficient to determine both location and orientation of the marker 100.

In alternative or additional embodiments, the identifier 102 as a whole may have rotational symmetry—for example lacking the further points 102c, 102d. In such embodiments, the marker 100 is sufficient to identify the location of the data 104, but not its orientation. In such embodiments, optical scanning may be performed in two or more orientations on the same location, and/or the optical scan data from a single scan may be processed in two or more different ways to check both orientations.

Finally, in some embodiments, a least-squares solution for the affine or homography transformation may be computed using all of the dots 102 in the identifier pattern to give a greater degree of accuracy.

The skilled person will appreciate that determining a correspondence between a reference pattern 800 and the dots 102 of a marker 100 allows a location (and in some embodiments orientation) of the data 104 of the marker 100 to be determined.

The skilled person will appreciate that any two arbitrary dots 102 can be selected to form either end of a line; identifying unique subsets 102a-d of dots 102 that maintain fixed geometric relations despite image transformations requires more than two dots. With three (or more) points it is possible to impose further constraints, such as the points being collinear (falling on a straight line) and being equidistant one from the next along the line (evenly spaced).

One specific embodiment of a marker 100 is shown in FIG. 1 and discussed above—the identifier 102 consists of two groups of three equidistant, collinear points marking the top and bottom sides of a region containing the data 104 to be extracted. Those six points 102a-b alone have a rotational ambiguity—it is not possible to differentiate between the set of points on the top and on the bottom, so one or more additional points 102c-d are necessary to fully solve the correspondence problem. In the specific embodiment discussed herein, a pattern of two points 102c on the right hand side and a single point 102d on the left serves to solve this ambiguity.

Once the correspondences between the detected points 102 and the points 804 in the reference pattern are known unambiguously, then it is possible to compute the image transformation to align the detected points 102 with the reference pattern 800 (both location and orientation). This transformation can then be used to produce a rectified view 1014 of the data of interest—for example text characters that will be passed on to an OCR algorithm. If the data region 804 is known to contain textual characters 104, these can be passed on to a standard OCR algorithm to extract the identity of the characters present. Alternatively or additionally, the data region 804 could contain data encoded in other forms such as a barcode; in this case the pattern 806 would serve the purpose of identifying the region of interest 104 and the image transformation, effectively serving as a “finder feature” in a barcode scheme.

To determine an affine transformation (representing orientation, scale, and skew transformations), only three point correspondences are required. For patterns containing more than three points a least-squares solution can be used to increase accuracy. With four correspondences or more a “homography” transformation can be determined, which can additionally represent perspective transformations due to the viewing angle of the pattern.

Other point patterns that result in a single unambiguous solution to the correspondence problem are also possible, for example a pattern containing different numbers of collinear, equidistant points on the top and bottom sides.

The skilled person will appreciate that this flexibility of the overall method to support different point pattern layouts may be advantageous. For example, space-constrained applications with less space vertically than horizontally may make use of a pattern 800 with points 802 only on the left and right sides of the data region 804 (see, for example, FIGS. 3B and 3D).

The skilled person will appreciate that identifier patterns containing more than the minimum number of points 102 required to compute a transformation may also allow the pattern to be detected even if some point detections are missing (due to, for example, marking errors, physical damage, or lighting conditions preventing one or more points from being detectable in a given image).

For example, the set second condition can be set such that if the central point in the second subset 102b is missing, this second subset can still be recognised as a potentially valid match to two out of the three points, as the line connecting the two points is approximately parallel to that in the first identified subset 102a, the length is similar to the length between the outer points in the first subset 102a, and the distance and positioning of the subset is within the acceptance regions. The skilled person will appreciate that this is a specific implementation provided by way of example only, and that similar tolerances of missing points can be introduced into the conditions for other dot arrangements.

FIG. 8 illustrates a template 800 for a marker 100.

The template 800 comprises a reference pattern 802 indicating the intended locations of dots of an identifier 102 and a data region 804 arranged to contain the data 104 of interest.

In the embodiment being described, the template 800 corresponds to the marker 100 shown in FIG. 1.

In the embodiment being described, the data region 804 comprises a rectangular grid of ten equally-spaced and sized rectangles, arranged in two rows of five. The rectangles may be thought of as cells of the grid. The skilled person will appreciate that grids 804 of other shapes and sizes may be used in other embodiments. In some embodiments, the data region 804 may not be subdivided (e.g. for a single barcode), or may be subdivided in a different way instead of into a grid.

In the embodiment being described, the dots 802 are located adjacent to the sides of the data region 804. In alternative or additional embodiments, one or more dots 802 may be located within the data region, for example between cells of a grid, preferably where the spacing between cells is at least equal to dot width.

In the embodiment being described, the dots 802 substantially surround the data region 804. In alternative or additional embodiments, the dots 802 may be located on only a subset of the sides of the data region 804, and/or may be within the data region 804.

In the embodiment being described, when an object or image is marked using the template 800 shown, each rectangle is between 1 and 3 mm high, and more particularly is 1.7 mm high. Further, each rectangle is between 0.5 and 2.5 mm wide, and more particularly is 1.10 mm wide. In the embodiment being described, the spacing is between 0.1 and 1 mm between adjacent rectangles, and more particularly is a spacing of 0.27 mm between adjacent rectangles.

In the embodiment being described, each dot 802 is between 0.2 and 1 mm across, and more particularly is 0.4 mm across and the spacing between collinear dots is between 0.2 and 1 mm, and more particularly is 0.6 mm (i.e. 1.0 mm from dot centre to dot centre).

In the embodiment being described, each dot 802 is positioned within a larger plain background—in this case a circular region of 1.6 mm diameter—to ensure that the dots 806 are clearly distinguishable from other features of an image including the marker. In the embodiment being described, the plain backgrounds of individual dots may overlap.

The skilled person will appreciate that other dimensions may be chosen in other embodiments.

Advantageously, the dots 802 are small compared to the data region 804. This may be particularly beneficial in embodiments in which limited space is available for a marker. In the embodiment being described, each dot 802 has a width of less than half the width of a cell 804a of the grid. In the embodiment being described, each dot 802 has a width of less than a tenth of the width of the data region 804.

FIGS. 6 and 7 describe an optional implementation of dot detection (step 502).

The skilled person will appreciate that there are many possible methods available for the step 502 of detecting all points in the image. One particular approach, inspired by the FAST corner detection method published in the paper “Machine learning for high-speed corner detection” by Eduard Rosten and Tom Drummond in Proceedings of European Conference on Computer Vision, 2006, is described herein.

FAST corner detectors are well suited to rapid implementations on current hardware. The idea is to treat the image as a discrete grid of pixels 600, and to decide on a pixel-by-pixel basis if it represents a corner. A ring 603 of discrete pixels around a central pixel 601 is considered to make this determination, as shown in FIG. 6. A ring of 16 pixels is used in the embodiments being described.

In alternative embodiments, a different number, n, of pixels may form the ring 603. The ring 603 may be a ring of pixels at a fixed radius surrounding the identified pixel 601—in the embodiment being described, the fixed radius is equal to 3 pixels and n is therefore 16 for the ring shape shown.

The skilled person would appreciate that other sizes and shapes of ring 603 could be used. In general, ring shape may be chosen to be rotationally symmetric (or approximately rotationally symmetric, given allowances for discrete pixels) so that responses are more isotropic than otherwise—in this way, if the image input is rotated, the same image features should still generate similar responses. For example, square, hexagonal or octagonal rings 603 could be chosen.

When using FAST as a corner detector, a certain contiguous segment of at least 9 pixels of this ring must contain pixels that are all brighter (or all darker) than the central pixel by more than a threshold amount set by the user. This metric identifies as corner pixels the tips of “wedge”-shaped structures in the image.

The reason this FAST metric permits very rapid implementations is that if two pixels on opposite sides of the ring (for example the leftmost ring pixel and the rightmost ring pixel) are both within the threshold of the central value then the pixel can be discarded, as no 9-pixel segments could meet the corner criteria for this pixel. Therefore pixels in regions of images with similar brightness levels can generally be discarded as potential corners after just two comparisons. Such regions of similar brightness occur frequently in natural images so many of the pixels in a given image can be rapidly discarded as corners in this way. Therefore extracting all potential corner pixel locations from an entire camera image can be completed rapidly.

A change to the FAST corner metric alters its behaviour so that dots are detected rather than wedge-shape structures. In embodiments of the invention, pixels are defined as representing dots when the central pixel 601 is either brighter or darker by more than a threshold of all of the 16 pixels in the ring 603 around the pixel under consideration. This results in even faster processing times than the FAST corner detectors, as pixels in regions of similar brightness can be discarded as potential points after a single comparison (if the compared pixel is within the threshold of the value of the pixel being considered).

A flow-chart 700 explaining the FAST point detection for “dark” points (where the central pixel 601 is darker than all surrounding 16 ring pixels) is shown in FIG. 7.

At step 702, a pixel 601 is chosen for consideration. This pixel 601 is referred to as the central pixel 601.

A ring of pixels 603 around the central pixel 601 is identified. In the embodiment being described, the ring contains 16 pixels. In alternative embodiments, a different shape and/or size may be chosen for the ring 603. The skilled person will appreciate that the ring size should ideally be chosen such that the whole of the dot 102 falls within the inner circumference of the ring, and such that the width of the ring is less than the spacing between dots 102.

At step 704, a threshold value is computed. The threshold value is based on a value of the central pixel 601, in this case a brightness value. The skilled person will appreciate that colour values may be used in some embodiments. In the embodiment being described, the threshold is the value of the central pixel 601 plus a set amount.

The comparisons against the ring pixels 603 check if the ring pixels are darker than the threshold. “Light” point detection follows an identical approach, but the threshold is determined by subtracting a set amount instead of adding a set amount if the same value is used.

At step 706 the value of a first pixel in the ring 603 is compared to the threshold.

If the value is within the threshold—i.e. the value does not differ from that of the central pixel 601 by more than the set amount—the centre pixel 601 is rejected as not being a dot and a new pixel is selected for consideration. The method 700 then returns to step 704.

If the value is outside of the threshold—i.e. the value differs from that of the central pixel 601 by more than the set amount—the method continues to step 708.

At step 708 the value of a second pixel in the ring 603 is compared to the threshold.

If the value is within the threshold—i.e. the value does not differ from that of the central pixel 601 by more than the set amount—the centre pixel 601 is rejected as not being a dot and a new pixel is selected for consideration 714. The method 700 then returns to step 704.

If, at step 714, it is determined that all pixels have been considered such that there is no next pixel for consideration, the method 700 ends—all pixels have been considered so the dot detection 700 is complete.

If the value is outside of the threshold—i.e. the value differs from that of the central pixel 601 by more than the set amount—the method continues to step 710.

At step 710 the value of a subsequent pixel in the ring 603 is compared to the threshold. If the value is within the threshold, the centre pixel 601 is rejected as not being a dot and a new pixel is selected 714 for consideration. If the value is outside of the threshold, the method continues for each subsequent pixel of the ring 603.

If all 16 pixels of the ring have values outside of the threshold, the method proceeds to step 712 and the centre pixel 601 is recorded as a dot detection.

If a single pixel of the ring has a value outside of the threshold, the method proceeds to step 714; the current centre pixel 601 is rejected and a new centre pixel chosen (or the method 700 ends, if complete).

In some embodiments, the ordering of the comparisons against ring pixels 603 is chosen to further accelerate the process by increasing the chance of rejecting a centre pixel 601 quickly. For example if the leftmost ring pixel value is outside the threshold of the central pixel 601, then at least one more test is necessary to reject the pixel (and 15 more will be necessary to confirm it as a point detection). It is likely neighbouring pixels to the leftmost one will have similar pixel values to the leftmost pixel and thus have the same result as the first comparison. For a higher likelihood of being able to reject the pixel after the second test, the rightmost pixel in the ring, which is furthest away from the one used in the first test, is therefore sampled next.

As described, the FAST-inspired point detection algorithm uses a fixed-sized ring of pixels 603. Thus any points in the image that are larger than the fixed-sized ring 603 will not be detected. Although the ring size could be increased to detect larger points, doing so would have an impact on the speed of the algorithm as many more pixels in the ring 603 would need to be tested 710 to confirm a dot detection.

A more efficient approach used in some embodiments involves using an “image pyramid”—producing multiple smaller-scale versions of the input image and processing each of these separately with the fixed-scale FAST point detector.

A half-sampling operation is one that rescales an input image to produce an output image of half the width and height. This can be achieved by averaging 2×2 pixel blocks in the input image to produce each output pixel, and can be implemented efficiently on current hardware. In this half-sampled image, point features that had a radius of 5 in the original image would have a radius of 2.5 pixels in the half-sampled image. Therefore these features would be detected as points by the fixed-sized ring 603 in the half-image, even though they would not have been detected in the full image.

An image pyramid is obtained by continuing to downsize the smaller images. Specifically, the half-sampled image can be half-sampled again to provide an image that is a quarter of the width and height of the original image. Each new level in the pyramid has only a quarter of the pixels of the previous level, so FAST detection on the new level should be roughly four times quicker than the previous one.

The FAST point ring of 603 will respond to point features in the image with a radius of between approximately 0.6 and 2.5 pixels. Therefore when applied on the half-image, features of radius between 1.2 and 5 pixels in the original image will be detected. The overlaps between these ranges of detectable point size imply that an image pyramid with half-sampling between each level image is sufficient to detect points of arbitrary radius in the original image.

The inherent fixed-sized response of the FAST method is an advantage for identifying 504 the first subset 102a of dots in the method 500 being described—the existence of a FAST point response in a particular image from the pyramid implies the size of the dot is between 0.6 and 2.5 pixels in that image. Those bounds on the dot size can be used to limit the search for dots in the first subset 102a based on the known ratio between dot size and the size of the gaps between points.

With current technology, it is possible for an implementation of this FAST point detector method to run (e.g. on a half-sampled image pyramid) in under 10 ms on mobile device hardware (e.g. a smart phone). The other aspects of detecting the full point pattern (grouping of points by geometric constraints and computing the full image transformation) can run in under 1 ms. Thus it is possible to run the entire method 400 to detect the region of interest at more than 30 frames per second (FPS) on resource-constrained mobile devices.

The high speed enabled by the presented method allows it to run on live frames produced by the internal camera of a mobile computing device such as a smartphone at 30 FPS or higher. This further allows the presented point pattern to be used as a target for Augmented Reality content; where additional digital content can be overlaid on the region of interest and will track the movement, scale and orientation of the article containing the region of interest as it is moved within the camera view.

FIG. 9 summarises a method 900 of marking an image or object with an optically readable marker. Such an object may be a beverage container, a part thereof or therefor, or any other item. Such an image may be an image arranged to be printed as a label, poster or the likes, or to be distributed or communicated electronically.

At step 902, the image or object is marked with the data 104 to be extracted. The data 104 may be alphanumeric characters, a barcode, other 2D encoded data or the likes.

At step 904, the image or object is marked with an identifier 102 arranged to identify a location of the data 104. The identifier 102 comprises a plurality of dots arranged in a set pattern, such as that shown in FIG. 1.

The marking with the data 104 and/or the identifier 102 may be performed by inkjet printing, laser etching, or any other suitable technique known to one skilled in the art.

1. An optically readable marker comprising:
data to be extracted; and
an identifier arranged to identify a location of the data to be extracted,
wherein the identifier comprises a plurality of dots of the same size arranged in a set pattern lacking rotational symmetry, such that an orientation of the data can be uniquely established, the plurality of dots comprising two sets of three collinear, equidistant dots arranged to indicate the presence of the identifier, and wherein the dots are small compared to the size of the data to be extracted and the two sets of collinear dots are parallel.

2. The optically readable marker of claim 1 wherein the identifier consists of the plurality of dots.

3. The optically readable marker of claim 1 wherein the data comprises alphanumeric characters.

4. The optically readable marker of claim 1 wherein the data are arranged in a grid, and wherein the plurality of dots are arranged to be adjacent to the grid.

5. The optically readable marker of claim 1 wherein the data are text-based data and each dot of the plurality of dots is small compared to a character of the text-based data.

6. (canceled)

7. (canceled)

8. The optically readable marker of claim 1 wherein the set pattern of the plurality of dots includes dots located near at least two sides of the data.

9. (canceled)

10. (canceled)

11. The optically readable marker of claim 1 wherein a distance between the first and second sets of three dots is within an expected range of distances relative to the spacing of dots in the first set.

12. The optically readable marker of claim 1 wherein the data to be extracted comprises at least one of the following:
(i) text-based data;
(ii) a barcode or QR code; and
(iii) encoded 2D binary data.

13. The optically readable marker of claim 1 wherein the dots surround the data to be extracted.

14. A beverage container comprising an optically readable marker comprising:
data to be extracted; and
an identifier arranged to identify a location of the data to be extracted,
wherein the identifier comprises a plurality of dots arranged in a set pattern lacking rotational symmetry, such that an orientation of the data can be uniquely established, the plurality of dots comprising two sets of three collinear, equidistant dots arranged to indicate the presence of the identifier, and wherein the dots are small compared to the size of the data to be extracted and the two sets of collinear dots are parallel.

15. (canceled)

16. (canceled)

17. A method of extracting data from an image, the method comprising:
obtaining an identifier reference pattern;
acquiring a two-dimensional image;
identifying an identifier within the image, the identifier comprising a plurality of dots arranged in a set pattern lacking rotational symmetry, such that an orientation of the data can be uniquely established, the plurality of dots comprising one or more sets of three collinear, equidistant dots arranged to indicate the presence of the identifier, wherein the dots are small compared to the size of the data to be extracted;
determining a location of the data to be extracted based on the identifier;
determining correspondences between detected dots of the identified identifier and known dots of the reference pattern;
based on the correspondences between the detected dots of the one or more sets of three collinear, equidistant dots of the identifier and the corresponding dots in the reference pattern, calculating an image transformation suitable for providing a rectified view of the data; and
optically scanning the determined location so as to extract the data.

18. The method of claim 17 wherein the acquiring a two-dimensional image comprises taking a photograph or using a live frame of a camera.

19. The method of claim 17 further comprising determining an orientation of the data to be extracted based on the identifier.

20. The method of claim 17 wherein the identifying an identifier within the image comprises:
detecting dots within the image;
identifying a first subset of dots which meet a first pre-set condition;
determining one or more expected positions of further dots based on the first subset of dots; and
searching for the further dots in the expected positions.

21. The method of claim 20 wherein the determining one or more expected positions of further dots comprises looking for a second subset of dots which meet a second pre-set condition with respect to the first subset of dots within an expected distance range of the first subset, the distance being determined relative to the spacing of dots in the first subset.

22. The method of claim 17 wherein:
(i) identifying each dot of the plurality of dots comprises identifying a pixel that is either brighter or darker by more than a threshold than all of the n pixels in a ring around the identified pixel; and/or
(ii) the optical scanning comprises performing optical character recognition on the determined location.

23. A method of marking an image or object with an optically readable marker, the method comprising:
marking the image or object with data to be extracted; and
marking the image or object with an identifier arranged to identify a location of the data, wherein the identifier comprises a plurality of dots of the same size arranged in a set pattern lacking rotational symmetry, such that an orientation of the data can be uniquely established, the plurality of dots comprising two sets of three collinear, equidistant dots arranged to indicate the presence of the identifier, and wherein the dots are small compared to the size of the data to be extracted and the two sets of collinear dots are parallel.

24. The method of claim 23 wherein the marking the object with the data to be extracted and with the identifier comprises laser etching, and/or wherein the object is a beverage can ring pull or container lid.

25. (canceled)

26. The method of claim 17 wherein either:
only three dot correspondences are determined, for a set of the one or more sets of three collinear equidistant dots, and the image transformation is an affine transformation; or
more than three dot correspondences are determined, and the image transformation is a homography transformation.

27. The optically readable marker of claim 1 wherein the optically readable marker further comprises one or more further dots, wherein the further dots are located at positions determinable from the positions of the dots in the two sets of collinear dots.
